(19) United States
(12) Patent Application Publication
(10) Pub. No.: US 2006/0184367 A1
(43) Pub. Date: Aug. 17, 2006

(54) Best method of computerized transcriptions

(76) Inventors: Anuthep Benja-Athon, New York, NY (US); Sirikit Benja-Athon, Port Washington, NY (US)

Correspondence Address: ANUTHEP BENJA-ATHON, 210 E 36TH ST., New York, NY, 10016, US

(21) Appl. No.: 11/255,229

(22) Filed: Oct. 21, 2005

Related U.S. Application Data
(63) Continuation-in-part of application No. 11/114,763, filed on Apr. 27, 2005.
Application No. 11/114,763 is a continuation-in-part of application No. 11/074,236, filed on Mar. 7, 2005.
Application No. 11/114,763 is a continuation-in-part of application No. 11/059,088, filed on Feb. 16, 2005.

(51) Int. Cl. G10L 17/00; G06Q 10/00

(52) U.S. Cl. 704/246; 705/2

(57) ABSTRACT

A method of labeling individual digital data with individual physicians' medical or surgical specialties and of corresponding words in digital text data to words in corresponding digital voice data wherein digital text data are generated by computer-automated conversions of digital voice data into digital text data and of corresponding words in digital voice data or digital text data with words in digital medical and surgical dictionaries and thesauruses for improving the accuracy of information between information in digital text data and their parent digital voice data.

This application is a continuation-in-part of Ser. No. 11/114,763 entitled System of Influencing Health-Care Utilizations filed Apr. 27, 2005 which is a continuation-in-part of U.S. Ser. No. 11/074,236 entitled System of Health-Care Resources file Mar. 7, 2005 and Ser. No. 11/059,088 entitled Consumers Buyers-Physicians Health-Care filed Feb. 16, 2005 which are pending.

### FIELD OF INVENTION

A system for generating the most accurate computerized transcriptions.

### BACKGROUND OF THE INVENTION

The present invention is the unique and foremost innovation of the application of speech recognition technology in health-care and medicine.

Prior art computerized conversion of a digital audio or voice data produced by a physician to digital text data is estimated to achieve only from 10%-80% accurate conversion. This range of accuracy is unacceptable and not practical. Multiple the above data and number of physicians by a few millions or several hundred thousands per day, the errors produce by prior art are massively large and totally unacceptable and rendering the speech recognition technology in health-care and medicine impractical.

The present invention infra resolves the above, problems and renders the practical use and application of the computerized conversion of digital voice data comprising health and health-care information on patients generate by tens or hundreds of thousands of physicians to corresponding digital text data.

Consequently, the present invention will rapidly cause the widespread applications of the best health-care system for improving the American health-care with all the human and socioeconomic benefits for all Americans and the world as provide by the earlier pending patent applications of these physician applicant and his co-applicants.

However, a fundamental to the rapid achievement of the goals set by said earlier patent applications is the present invention which provides the most effective system of allowing a network of computers and servers to rapidly and accurately convert the products of the thought processes of more than 600,000 American physicians' brains—and those of physicians in the other parts of the world and other people—into digital data in computer means for storing data and in computer means for displaying said data to all parties involved.

Therefore, the present invention provides a system and a method for accurately and rapidly converting massive data on health and health-care information on hundred of millions of patients generate by the millions of brains of physicians into digital data. The present invention is the only system of causing physicians in America and the world to adopt and practice the processes of converting the products of their thought processes on the data on health and health-care information on their patients into computer digital data.

The present invention's benefits and benevolent affects on humanity are immense as the present invention will surely cause billions of health-care dollars, tangible and intangible benefits per day to positively affect and improve the lives of millions of people in America and the world. The current health-care crisis is therefore resolved by this physician applicant and his co-applicants.

### SUMMARY OF THE INVENTION

The present invention is the unique and foremost innovation of the application of speech recognition technology in health-care and medicine as no one in the history of humankind has ever reached this realm of innovation in health-care and medicine.

The present invention provides a system or a method for maximizing the accuracy of information between information in digital text data and their parent digital voice or audio data generated by physicians. It provides a process of labeling or tagging individual digital data with individual physicians' medical or surgical specialties for efficiently handling, processing and managing massive digital data generate every day by physicians. It provides a process of corresponding words in said digital text data to words in corresponding said digital voice data wherein said digital text data are generated by computer-automated conversions of said digital voice or audio data into said digital text data. It provides a process of corresponding words in digital voice data with words in digital medical and surgical dictionaries and thesauruses. Furthermore, it provides a process of corresponding words in digital text data with words in digital medical and surgical dictionaries and thesauruses.

### DESCRIPTION OF THE PREFERRED EMBODIMENTS

The present invention provides the best method for computerized medical transcriptions of health and health-care information which are generated by physicians. It is the system or the method of improving or maxizing the accuracy of the information in digital text data and the information in their parent digital voice or audio data in the computer-automated conversions of said digital voice data into said digital text data. The present invention is a system or a method of labeling individual digital data comprising health and health-care information on patients with individual physicians' medical or surgical specialties and of corresponding words in each of said data to words in corresponding digital medical or surgical specialty dictionaries of words for improving the accuracy of information between information contents in digital text data and their parental digital voice wherein said digital text data are generated by computer-automated conversions of said digital voice data into said digital text data.

The present invention comprises a process of associating individual physicians' digital voice data generate by said individual physicians with corresponding individual digital medical and surgical specialty dictionaries of words in voice recognition technology (SRT) application. There are about 70 digital medical and surgical specialty dictionaries of words corresponding to about 70 medical and surgical specialties practice by about 600,000 American physicians. To use the present invention, each physician with a specific specialty such as neurology who uses the present invention is required to teach or train the computer SRT software in a computer or server having said SRT and software to recognize said physician's idiosyncratic voice and words or to match said physician's recorded digital voice and words produced by said physician's digital voice recorder. To achieve said recognition, said neurologist, said computer or server and said software process said physician's digital voice data comprise a dictionary of large number of neurology words, numbers, terms, phrases and/or sentences mostly relating to neurology and corresponding digital neurology dictionary of thousands neurology words, numbers, terms and perhaps phrases and related in the memory or cache of said computer or server.

Similarly, a rheumatologist is required to teach or train the computer SRT software in a computer or server having said SRT and software to recognize said physician's idiosyncratic voice and words or to match said physician's recorded digital voice and words produced by said physician's digital voice recorder. To achieve said recognition, said rheumatologist, said computer or server and said software process said physician's digital voice data comprise a dictionary of large number of rheumatology words, numbers, terms, phrases and/or sentences mostly relating to rheumatology and corresponding digital rheumatology dictionary of words, numbers, terms and perhaps phrases and related in memory or cache of said computer or server.

The above settings and processes are repeated for each and all physicians in about 70 medical and surgical specialties such as, but not limited to, allergists, endocrinologists, immunologists, gastroenterologists, nephrologists, oncologists, radiologists, general surgeons, plastic surgeons using the present invention every time.

To achieve supra and infra, the memories or caches of computers and/or servers in the system of computers and servers have medical and surgical dictionaries and thesauruses comprising tens or hundreds of thousands of words, numbers, terms, phrases, codes and labels on said medical and surgical specialties to permit the processes of applying a plurality of medical specialty dictionaries of words, terms, phrases, codes and labels to achieve the objectives of the present invention.

Further to supra, it is understood that the above process also comprises a process of using words, numbers, terms, phrases and sentences that are not in a physician's medical or surgical specialty or practice. In other words, in order to effectively communicate, document or record information and to generate meaningful, accurate or correct health and health-care information on a patient and patients by a physician in his/her clinical practice, a physician can and will incorporate non-medical and other medical and surgical words, numbers, terms, phrases and sentences from other medical and surgical specialties outside his/her specialty in the construction of terms, phrases and/or sentences in the digital data in the claims of the present invention. For example, any physician such as, but not limited to, a neurologist can and will generate words, numbers, terms, phrases and sentences relating to his/her neurology specialty or practice and to other medical and surgical specialties such as, but not limited to, endocrinology, rheumatology, orthopaedics, urology, nephrology and pharmacology. Said examples apply to all physicians belonging to 70 medical and surgical specialties such as, but not limited to, allergists, endocrinologists, immunologists, gastroenterologists, nephrologists, oncologists, radiologists, general surgeons and plastic surgeons.

The present invention further provides a process of labeling or tagging individual physicians' digital data with individual corresponding physicians' medical or surgical specialties. The computer-automated process is the preferred embodiments of achieving said labeling process. In other words, computers including digital voice records and servers label or tag individual physicians' individual digital voice data with said physicians' corresponding medical or surgical specialties with corresponding medical or surgical specialties of said physicians. For example, a computer including digital voice record and server can label or tag an endocrinologist's digital voice data on any and all of said endocrinologist's data with the endocrinology specialty in a form of code, label, tag or the like. Similarly, a computer including digital voice record and server can label or tag a neurosurgeon's digital voice data on any and all of said neurosurgeon's data with the neurosurgery specialty in the form of a code, label or the like. The above settings and processes are repeated for each and all physicians in about 70 medical and surgical specialties using the present invention every time. Said examples apply to all physicians belonging to 70 medical and surgical specialties. The above applies to physicians' digital voice data and digital text data.

By said process of labeling or tagging said individual digital data, said individual physicians' digital data numbering—perhaps in hundreds of thousands or millions per day—are identified or sorted according to said specialty code, label or the like early in the process. Therefore, a process of the present invention uniquely and efficiently handles, processes and manages massive digital data generate daily by physicians to achieve the objectives of the present invention. For example, physicians' digital data similarly labeled or coded are directed and processed by certain computer means for processing similarly labeled or coded digital data while other physicians' digital data similarly labeled or coded are directed and processed by other computer means for processing similarly labeled or coded digital data.

The present invention provides processes of comparing information in digital text data with the corresponding information in their parental digital voice data. One of the processes is to computer-automatically compare said information in said digital text data to corresponding information in said digital voice data from which said digital text data are derived from corresponding said digital voice data by said computer-automated process. For example, an allergist's the information in a digital text data on a patient derived from the information in said allergist's digital voice data on said patient is computer-automatically compared with the said original information in said digital voice data. The objective is to identify the mismatching of word, words, number, numbers, term, terms, phrase, phrases or any combination thereof between said information in said digital text data and digital voice data.

Furthermore, the present invention provides a process of checking the spellings of words, numbers, terms, phrases, sentences or any combination thereof in said digital text data against words, terms, phrases, sentences or any combination thereof in the medical and surgical dictionaries and thesauruses in the memories or caches of computers and/or servers in the system of computers and servers to achieve the objectives of the present invention. The present invention provides a process of computer-automatically compare said information in said digital text data to corresponding information in said digital voice data from which said digital text data are derived from corresponding said digital voice data by said computer-automated process. For example, an opthalmologist's information in a digital text data on a patient derived from the information in said opthalmologist's digital voice data on said patient is computer-automatically compared with a dictionary and/or thesaurus on words, numbers, terms, phrases, codes and labels in ophthalmology in the memory or cache of computer and/or server in the system of computers and servers.

The objective is to maximize the correct words, phrases or sentences in said data. Said example applies to all physicians belonging to 70 medical and surgical specialties.

The present invention includes and provides a means for displaying the outcomes of said processes on the display screens of computers in a network of computers. Furthermore, to facilitate said displays and also the identifications of a word, words, a term, terms, a phrase, phrases, a sentence and/or sentences on said display screens of, visual and/or auditory means for highlighting or accentuating said words, terms, phrases and/or sentences is used.

Another process although less preferred to said computer-automated process, a process of comparing of said digital data comprises a process of listening to digital voice data and reading corresponding digital text data.

The medical specialty and medical specialties being used in the claims of the present invention infra are to be understood to encompass or represent a medical specialty or medical practice and a surgical specialty or practice and any or all 70 medical and surgical specialties, respectively, such as, but not limited to, immunology, neurology, rehabilitation medicine, pain medicine, cardiology, orthopaedic, general surgery, cardiothoracic surgery, pediatric and rheumatology.

Further to supra, it is understood that the digital medical specialty dictionary and dictionaries in the claims of the present invention infra are to be understood to encompass words, numbers, terms, phrases, sentences, codes, labels use by any and all physicians of 70 medical and surgical specialties and neither are confined nor limited to words, numbers, terms, phrases, sentences, codes and labels within a physician's medical or surgical specialty or practice. In other words, in order to effectively communicate, document or record information and to generate meaningful, accurate or correct health and health-care information on a patient and patients by a physician in his/her clinical practice, a physician can and will incorporate non-medical and other medical and surgical words, numbers, terms, phrases, sentences, codes and labels from other medical and surgical specialties outside his/her specialty in the construction of terms, phrases and/or sentences in the digital data in the claims of the present invention. For example, any physician such as, but not limited to, a neurologist can and will generate words, numbers, terms, phrases, sentences, codes and labels in his/her neurology specialty or practice and also from other medical and surgical specialties or practices such as, but not limited to, endocrinology, rheumatology, orthopaedics, urology, nephrology, pharmacology and general surgery. Said example and setting applies to each and all physicians practice about 70 medical and surgical specialties.

It is to be understood that specialty and specialties infra also embody or comprise words, numbers, terms, phrases, sentences, codes and labels in pharmacology and pharmaceutics use by physicians and pharmacists such as, but not limited, names of drugs and medications, doses and uses and toxicology such as, but not limited to, names of toxic substances.

Moreover, it is to be understood that said labels or tags of said digital data are such as, but not limited to, words, numbers, alphabetic codes, numeral codes or alphanumeric codes representing about 70 medical and surgical specialties.

It is to be understood that said dictionaries also comprise dictionaries of diagnoses and dictionaries of treatments and procedures in all or about 70 medical and surgical specialties.

Although various preferred embodiments of the present invention have been described for patients, physicians and other health-care providers, it will be appreciated by those skilled in the art that adaptations and variations may be made to apply to other businesses and industries such as, but not limited, law, lawyers and government and their clients, veterinarians and animals, engineering and engineers without departing from the spirit of the invention and the scope of the claims.

Although various preferred embodiments of the present invention have been described, it will be appreciated by those skilled in the art that adaptations and variations may be made without departing from the spirit of the invention and the scope of the claims.

1. A method of improving the accuracy of the information in digital text data between the information in their parent digital voice data in computer-automated conversions of said digital voice data into said digital text data comprises:
a process of associating a physician's digital voice data generate by said physician with a digital medical specialty dictionary of words;
a process of associating individual physicians' digital voice data generate by said individual physicians with individual corresponding digital medical specialty dictionaries of words;
a process of labeling a physician's digital voice data with said physician's medical specialty;
a process of labeling individual physicians' individual digital voice data with individual corresponding medical specialties of corresponding physicians;
a process of labeling a physician's digital text data with said physician's medical specialty;
a process of labeling physicians' individual digital text data with individual corresponding medical specialties of corresponding physicians;
a process of directing similarly labeled digital data to computer means for processing similarly labeled digital data
a process of comparing information in said digital voice data to corresponding information in said digital text data;
a process of applying a plurality of medical specialty dictionaries of words;
a process of applying a plurality of surgical specialty dictionaries of words;
a process of relating individual digital text data to individual digital medical specialty dictionaries of words;
a process of corresponding a word in a digital text data to a word in a digital medical specialty dictionary of words;
a process of corresponding a word in a digital text data to a plurality of words in a digital medical specialty dictionary of words;
a process of corresponding a plurality of words in a digital text data to a word in a digital medical specialty dictionary of words;
a process of corresponding a plurality of words in a digital text data to a plurality of words in a digital medical specialty dictionary of words;
a process of corresponding words in individual digital text data to words in individual corresponding digital medical specialty dictionaries of words;
a process of checking the spellings of words in said digital text data;
a process of accentuating a word in said digital text data; and
a process of accentuating a plurality of words in said digital text data.

2. The method according to claim 1 wherein said a process of relating individual digital voice data to individual medical specialties of individual physicians comprises a process of labeling individual digital voice data with individual specialties of physicians.

3. The method according to claim 1 wherein said a process of relating individual digital voice data to individual medical specialties of individual physicians comprises a process of labeling individual digital text data with individual specialties of physicians.

4. The method according to claim 1 wherein said process of comparing information in said digital voice data to corresponding information in said digital text data comprises a computer-automated process of comparing data in individual digital voice data and corresponding individual data in digital text data.

5. The method according to claim 1 wherein said process of comparing information in said digital voice data to corresponding information in said digital text data comprises a process of listening to digital voice data.

6. The method according to claim 1 wherein said process of comparing information in said digital voice data to corresponding information in said digital text data comprises a process of reading digital text data.

7. A method of improving the accuracy between the information contents in digital text data and the information contents in their parent digital voice data in computer-automated conversions of said digital voice data comprising health and health-care information on patients into said digital text data comprises:
a process of associating a physician's digital voice data generate by said physician with a digital medical specialty dictionary of words;
a process of associating individual physicians' digital voice data generate by said individual physicians with individual corresponding digital medical specialty dictionaries of words;
a process of labeling a physician's digital voice data with said physician's medical specialty;
a process of labeling individual physicians' individual digital voice data with individual corresponding medical specialties of corresponding physicians;
a process of labeling a physician's digital text data with said physician's medical specialty;
a process of labeling physicians' individual digital text data with individual corresponding medical specialties of corresponding physicians;
a process of directing similarly labeled digital data to computer means for processing similarly labeled digital data
a process of comparing information in said digital voice data to corresponding information in said digital text data;
a process of applying a plurality of medical specialty dictionaries of words;
a process of applying a plurality of surgical specialty dictionaries of words;
a process of relating individual digital text data to individual digital medical specialty dictionaries of words;
a process of corresponding a word in a digital text data to a word in a digital medical specialty dictionary of words;
a process of corresponding a word in a digital text data to a plurality of words in a digital medical specialty dictionary of words;
a process of corresponding a plurality of words in a digital text data to a word in a digital medical specialty dictionary of words;
a process of corresponding a plurality of words in a digital text data to a plurality of words in a digital medical specialty dictionary of words;
a process of corresponding words in individual digital text data to words in individual corresponding digital medical specialty dictionaries of words;
a process of checking the spellings of words in said digital text data;
a process of accentuating a word in said digital text data; and
a process of accentuating a plurality of words in said digital text data.

8. A method of labeling individual digital data comprising health and health-care information on patients with individual physicians' medical or surgical specialties and of corresponding words in each of said data to words in corresponding digital medical or surgical specialty dictionaries or thesauruses of words for improving the accuracy of information between information contents in digital text data and their parent digital voice data wherein said digital text data are generated by computer-automated conversions of said digital voice data into said digital text data comprises:
a process of associating a physician's digital voice data generate by said physician with a digital medical specialty dictionary of words;
a process of associating individual physicians' digital voice data generate by said individual physicians with individual corresponding digital medical specialty dictionaries of words;
a process of labeling a physician's digital voice data with said physician's medical specialty;
a process of labeling individual physicians' individual digital voice data with individual corresponding medical specialties of corresponding physicians;
a process of labeling a physician's digital text data with said physician's medical specialty;
a process of labeling physicians' individual digital text data with individual corresponding medical specialties of corresponding physicians;
a process of directing similarly labeled digital data to computer means for processing similarly labeled digital data
a process of comparing information in said digital voice data to corresponding information in said digital text data;
a process of applying a plurality of medical specialty dictionaries of words;
a process of applying a plurality of surgical specialty dictionaries of words;
a process of relating individual digital text data to individual digital medical specialty dictionaries of words;
a process of corresponding a word in a digital text data to a word in a digital medical specialty dictionary of words;
a process of corresponding a word in a digital text data to a plurality of words in a digital medical specialty dictionary of words;
a process of corresponding a plurality of words in a digital text data to a word in a digital medical specialty dictionary of words;
a process of corresponding a plurality of words in a digital text data to a plurality of words in a digital medical specialty dictionary of words;
a process of corresponding words in individual digital text data to words in individual corresponding digital medical specialty dictionaries of words;
a process of checking the spellings of words in said digital text data;
a process of accentuating a word in said digital text data; and
a process of accentuating a plurality of words in said digital text data.
